(19) United States
(12) Patent Application Publication
(10) Pub. No.: US 2016/0004195 A1
(43) Pub. Date: Jan. 7, 2016

(54) IMAGE FORMING APPARATUS, FIXING TEMPERATURE CONTROL METHOD, AND FIXING TEMPERATURE CONTROL PROGRAM

(71) Applicant: Konica Minolta, Inc., Tokyo (JP)

(72) Inventors: Masahiro OZAWA, Tokyo (JP); Kiyoshi EMORI, Osaka (JP); Takahisa MATSUNAGA, Tokyo (JP); Mitsuharu HAYASAKA, Tokyo (JP); Yasufumi AOYAMA, Tokyo (JP); Tetsuren NOGAWA, Tokyo (JP)

(73) Assignee: KONICA MINOLTA, INC., Tokyo (JP)

(21) Appl. No.: 14/751,961

(22) Filed: Jun. 26, 2015

(30) Foreign Application Priority Data
Jul. 1, 2014 (JP) 2014-135885

(51) Int. Cl. G03G 15/20

(52) U.S. Cl. CPC G03G 15/2039; G06K 15/1867

(57) ABSTRACT

An image forming apparatus includes: a printing unit that includes an image forming unit that forms a toner image of each page on recording paper, and a fixation unit that thermally fixes the toner image on the recording paper; and a control unit that controls the printing unit and includes a data acquisition unit, an analysis unit, a rasterization unit, and a printing control unit, wherein the analysis unit includes a band division unit that divides each page into a plurality of bands, and a condition determination unit that determines whether or not low temperature fixation executed at a relatively low temperature is allowed for each of the bands, and sets a fixing temperature for each of the bands based on a determination result, and the printing control unit controls a fixing temperature of the fixation unit based on the fixing temperature set for each of the bands.

The entire disclosure of Japanese Patent Application No. 2014-135885 filed on Jul. 1, 2014 including description, claims, drawings, and abstract are incorporated herein by reference in its entirety.

### BACKGROUND OF THE INVENTION

1. Field of the Invention

The present invention relates to an image forming apparatus, a fixing temperature control method, and a fixing temperature control program. More particularly, the present invention relates to an image forming apparatus which includes a printing unit for thermally fixing a toner image formed on recording paper, and further to a fixing temperature control method and a fixing temperature control program for the image forming apparatus.

2. Description of the Related Art

An electrographic image forming apparatus applies light from an exposing device to a photosensitive drum uniformly charged by a charging device to form an electrostatic latent image, and attaches toner to the electrostatic latent image using a developing device to develop the electrostatic latent image into a toner image. Then, the image forming apparatus transfers the toner image on the photosensitive drum to recording paper through a medium of an intermediate transfer belt, and thereafter performs a fixing process for fixing the toner image on the recording paper by heating the toner image using a fixing device. A fixing temperature necessary for fixing a toner image differs depending on conditions such as an attachment amount of toner, and an image type formed on recording paper. Accordingly, the fixing temperature is generally set to a target temperature sufficient for securing preferable fixation even in a state requiring the highest temperature, so that secure fixation can be achieved under any conditions.

However, when thermal fixation is performed at this target temperature for all images, excessively high power may be consumed. This situation is not preferable in view of energy saving. Accordingly, various methods have been proposed for lowering the target temperature of thermal fixation so as to reduce power consumption of an image forming apparatus.

For example, according to a technology disclosed in JP 2013-164441 A, a candidate value of a target temperature is calculated based on color information on an image contained in a page, while a temperature correction value is calculated based on the presence or absence of a half tone image portion of the image contained in the corresponding page, and based on a type of gradation processing unit performing image processing for the half tone image portion. Then, the temperature correction value is subtracted from the candidate value to calculate and set the target temperature.

According to a technology disclosed in JP 2011-123212 A, a half tone process method determining unit compares a fixing temperature set by a half tone process method for printing data on current paper with a fixing temperature set by a half tone process method set for printing data on previous paper, and determines a half tone process method capable of reducing a change of the set fixing temperature as a half tone process method to be executed for a current printing medium. Then, a PDL unit adjusts the set fixing temperature based on printing data processed by the determined half tone process method, whereafter a printing unit forms an image at the adjusted set fixing temperature.

There is further disclosed in JP 2013-003418 A, a technology which determines a fixing temperature based on image contents analyzed by an image analysis unit. According to this technology, a fixing temperature level is adjusted to any one of levels in a range from the highest fixing temperature level k0 to the lowest fixing temperature level kn for each contents of color information, dither information, and image information.

There is further disclosed in JP 2012-118496 A, a technology which includes a fixing target temperature variable unit for varying a fixing target temperature for fixation, and a gradation processing unit which performs gradation processing for image information. According to this technology, the fixing target temperature is varied based on the presence or absence of half tone processing, and a type of gradation processing to be adopted for each recording medium subjected to fixing processing. There is further disclosed in JP 2013-003506 A, a technology which allows rearrangement of an image formation order based on a fixing target temperature. There is further disclosed in JP 2012-242751 A, a technology which varies a fixing target temperature based on a type and a gradation value of gradation processing adopted for an image on a recording medium for each recording medium subjected to fixing processing.

There is further disclosed in JP 2011-191697 A, a fixing control method which includes: a power saving instruction determining step for preparing database that associates a plurality of dithers with corresponding fixing temperature target values determined for realizing power saving, and determining whether or not a power saving process that designates a power saving level for printing data has been issued; a power saving operation condition determining step for acquiring, from the database, a fixing temperature target value corresponding to a type of dither selected in accordance with drawing conditions obtained as an analysis result of the printing data, and determining a fixing temperature target value and a type of dither to be adopted based on the acquired fixing temperature target value and the instruction for the power saving process determined in the power saving instruction determining process; a drawing step for creating output image data in accordance with the type of dither determined in the power saving operation condition determining step; and a step for making adjustment to the fixing temperature target value determined in the power saving operation condition determining step.

According to a technology disclosed in JP 2011-197322 A, a fixing temperature and paper feed speed determining unit determines control target values of a fixing temperature and a paper feed speed based on a fixing temperature for realizing power saving which has a predetermined relationship with dither intended to be used and selected by an intermediate data storage unit based on drawing conditions such as a drawing command obtained by analysis of printing data, and based on an energy saving level designated by a user and determined by an energy saving determining unit. Then, the fixing temperature and paper feed speed determining unit notifies a printer engine of the determined control target values. When a high energy saving level is set, a paper feed speed control target value is decreased along with a change of the fixing temperature target value for fixing control to a lower value, so as to further reduce power consumption of a heater while maintaining an amount of heating for fixation and avoiding lowering of image quality.

According to the foregoing conventional technologies, a fixing temperature is set for each page based on conditions such as whether an image to be formed on recording paper is a color image or a monochrome image, whether a half tone image is present or absent, and whether a half tone process method is dither method or random dither method. A certain degree of power saving is achievable by setting a fixing temperature for each page as in these methods.

A printing target page often contains a number of objects. Some of the objects require fixation at a normal temperature (called high temperature fixation), while others allow fixation at a temperature lower than the normal temperature (called low temperature fixation). For example, objects such as colored objects, image objects, and half-tone objects require high temperature fixation, while objects such as monochrome text objects and graphic objects allow low temperature fixation.

However, the conventional technologies set a fixing temperature for each page, and determine the fixing temperature in correspondence with objects requiring high temperature fixation when the corresponding page contains a mixture of objects requiring high temperature fixation and objects allowing low temperature fixation. In this case, high temperature fixation is performed even for objects allowing low temperature fixation, in which situation sufficient reduction of power consumption is difficult to achieve.

Moreover, the conventional technology set a fixing temperature for each page, and does not start printing until arrival of a fixing device temperature at a temperature necessary for high temperature fixation even when a page head contains objects allowing low temperature fixation. In this case, efficient printing is difficult to achieve.

### SUMMARY OF THE INVENTION

The present invention has been developed to solve the aforementioned problems. A main object of the present invention is to provide an image forming apparatus, a fixing temperature control method, and a fixing temperature control program, capable of sufficiently reducing power consumed by fixing processing when a page contains a mixture of a part requiring high temperature fixation and a part allowing low temperature fixation.

Another object of the present invention is to provide an image forming apparatus, a fixing temperature control method, and a fixing temperature control program, capable of efficiently performing printing by starting fixing processing earlier.

To achieve at least one of the abovementioned objects, according to an aspect, an image forming apparatus reflecting one aspect of the present invention comprises: a printing unit that includes an image forming unit that forms a toner image of each page on recording paper based on printing data, and a fixation unit that thermally fixes the toner image on the recording paper; and a control unit that controls the printing unit and includes a data acquisition unit that acquires the printing data, an analysis unit that analyzes the printing data and creates a display list, a rasterization unit that creates bitmap data based on the display list, and a printing control unit that transmits the bitmap data to the printing unit, and instructs the printing unit to perform printing, wherein the analysis unit includes a band division unit that divides each page into a plurality of bands, and a condition determination unit that determines whether or not low temperature fixation executed at a relatively low temperature is allowed for each of the bands, and sets a fixing temperature for each of the bands based on a determination result, and the printing control unit controls a fixing temperature of the fixation unit based on the fixing temperature set for each of the bands.

To achieve at least one of the abovementioned objects, according to an aspect, a fixing temperature control method for an image forming apparatus that includes a printing unit that includes an image forming unit that forms a toner image of each page on recording paper based on printing data, and a fixation unit that thermally fixes the toner image on the recording paper, the method reflecting one aspect of the present invention executes: a data acquisition process that acquires the printing data; an analysis process that analyzes the printing data and creates a display list; a rasterization process that creates bitmap data based on the display list; and a printing process that transmits the bitmap data to the printing unit, and instructs the printing unit to perform printing, wherein the analysis process divides each page into a plurality of bands, determines whether or not low temperature fixation executed at a relatively low temperature is allowed for each of the bands, and sets a fixing temperature for each of the bands based on a determination result, and the printing process controls a fixing temperature of the fixation unit based on the fixing temperature set for each of the bands.

To achieve at least one of the abovementioned objects, according to an aspect, a non-transitory recording medium storing a computer readable fixing temperature control program, the program reflecting one aspect of the present invention operates in an apparatus that controls a printing unit including an image forming unit that forms a toner image of each page on recording paper based on printing data, and a fixation unit that thermally fixes the toner image on the recording paper, wherein under the program, the apparatus executes an analysis process that analyzes the printing data and creates a display list, a rasterization process that creates bitmap data based on the display list, and a printing process that transmits the bitmap data to the printing unit, and instructs the printing unit to perform printing, and the analysis process divides each page into a plurality of bands, determines whether or not low temperature fixation executed at a relatively low temperature is allowed for each of the bands, and sets a fixing temperature for each of the bands based on a determination result, and the printing process controls a fixing temperature of the fixation unit based on the fixing temperature set for each of the bands.

### BRIEF DESCRIPTION OF THE DRAWINGS

The above and other objects, advantages and features of the present invention will become more fully understood from the detailed description given hereinbelow and the appended drawings which are given by way of illustration only, and thus are not intended as a definition of the limits of the present invention, and wherein:

FIG. 1 is a block diagram illustrating a configuration of an image forming apparatus according to an embodiment of the present invention;

FIGS. 2A and 2B are views illustrating a configuration of a control unit, and general operation of a print process of the image forming apparatus according to the embodiment of the present invention;

FIG. 3 is a view schematically illustrating a configuration of a printing unit of the image forming apparatus according to the embodiment of the present invention;

FIG. 4 is a flowchart showing operation (print process) of the image forming apparatus according to the embodiment of the present invention;

FIG. 5 is a flowchart showing operation (command analysis process) of the image forming apparatus according to the embodiment of the present invention;

FIG. 6 is a flowchart showing operation (rasterization process) of the image forming apparatus according to the embodiment of the present invention;

FIG. 7 is a flowchart showing operation (printing) of the image forming apparatus according to the embodiment of the present invention;

FIG. 8 is a view illustrating division units (bands) in the print process of the image forming apparatus according to the embodiment of the present invention;

FIG. 9 is a table showing determination conditions for determining whether or not low temperature fixation is allowed in the image forming apparatus according to the embodiment of the present invention;

FIG. 10 is a table showing a relationship between bands and fixing temperatures (before change) in the print process of the image forming apparatus according to the embodiment of the present invention;

FIG. 11 is a table showing a relationship between bands and fixing temperatures (after change) in the print process of the image forming apparatus according to the embodiment of the present invention;

FIG. 12 is a flowchart showing operation (fixing temperature determination process) of the image forming apparatus according to the embodiment of the present invention;

FIGS. 13A and 13B are views illustrating effects of fixing temperature control at a printing start according to the embodiment of the present invention; and

FIGS. 14A and 14B are views illustrating effects of fixing temperature control at a printing end according to the embodiment of the present invention

### DESCRIPTION OF THE PREFERRED EMBODIMENTS

Hereinafter, an embodiment of the present invention will be described with reference to the drawings. However, the scope of the invention is not limited to the illustrated examples.

As discussed in the section of “Description of the Related Art”, an electrographic image forming apparatus transfers a toner image formed on a photosensitive drum to recording paper, and performs fixing processing for fixing the toner image on the recording paper by heating the toner image using a fixing device. This fixing processing requires heating of a fixing portion within the fixing device to a predetermined temperature, and therefore consumes a large amount of power. For representing this amount of power consumption, an image forming apparatus generally adopts a Typical Electricity Consumption (TEC) value, which value is largely dependent on a fixing method. For example, the TEC value varies in accordance with conditions such as whether a heating unit is a halogen heater, a ceramic heater, or an induction heating belt, whether the fixing device is constituted by an upper double axis belt system (system including a heating roller and a fixing roller both disposed above paper and connected by a belt) or a pad system (system pressing a roller disposed above paper by a pad disposed below paper).

In any of these fixing methods, reduction of the TEC value is needed. Accordingly, in the conventional cases, it is determined for each page which of high temperature fixation and lower temperature fixation is to be carried out based on conditions such as whether an image formed on recording paper is a color image or a monochrome image, whether a half tone image is present or absent, and whether half tone processing is dither method or random dither method, for example.

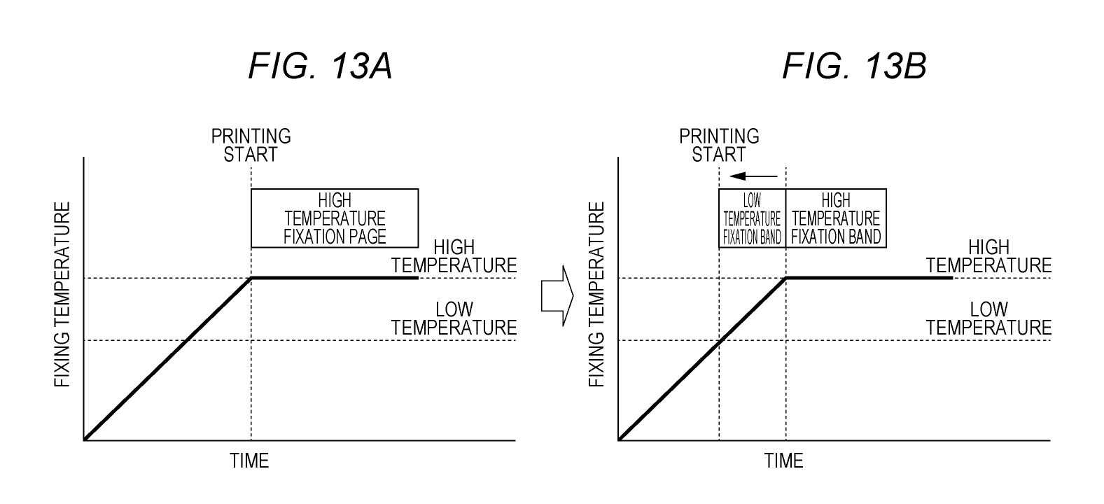

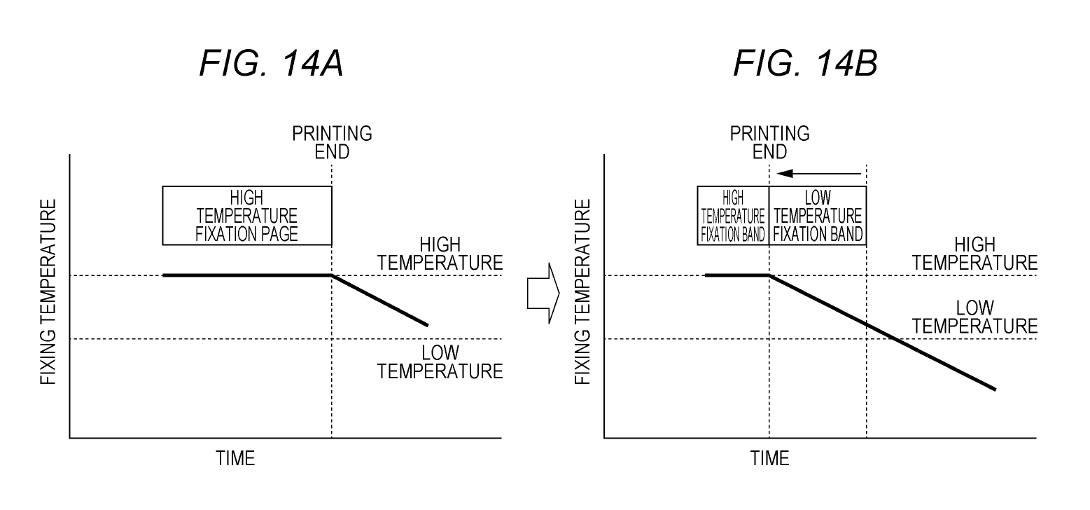

However, according to the method which controls a fixing temperature for each page, high temperature fixation needs to be executed for a whole page when a printing target page contains at least a small amount of objects requiring high temperature fixation. In this case, the temperature of the fixing device is raised to a temperature necessary for high temperature fixation by the time of a start of fixing processing for a page head as illustrated in FIG. 13A. Accordingly, when a part allowing low temperature fixation is contained, power is uselessly consumed by high temperature fixation performed for this part. In addition, printing is difficult to start in this situation even in a state allowing low temperature fixation. Furthermore, the temperature of the fixing device is maintained at the temperature necessary for high temperature fixation until completion of fixing processing for a page end as illustrated in FIG. 14A. Accordingly, even when only a part allowing low temperature fixation remains, power is uselessly consumed by high temperature fixation for this part.

According to the conventional methods, whether or not low temperature fixation is allowed is determined based on color designation, the presence or absence of a half tone image, or a method of half tone processing, for example. However, experiments conducted by the present inventors have clarified that sufficient toner detachment strength is difficult to secure even when these conditions are met. More specifically, in an image containing dots disposed at long intervals such as a half tone image, a major part of toner adheres to recording paper as isolated small dots, and therefore easily separates from the recording paper. Accordingly, the presence or absence of a half tone image has a large effect on the toner detachment strength. However, in consideration of detachment strength at the time of folding of the recording paper as well, the degree of detachment is variable depending on line widths of characters or figures, according to the findings of the present inventors. This variation of the degree of detachment is considered to be produced for the following reason. In case of an image having a small line width, heat is easily conducted to entire toner, wherefore bonding between toner particles is promoted to a level sufficient for maintaining detachment strength even at a relatively low temperature. However, in case of an image having a large line width, heat is not easily conducted to entire toner, wherefore sufficient detachment strength is difficult to maintain due to insufficient bonding between toner particles.

For overcoming this problem, the present applicant has proposed a fixing mode (called “smart fixation”) which considers toner detachment at the time of folding of recording paper as well based on the foregoing experiments, as a method of control for lowering a fixing temperature when drawing contents in a page fall within a range of particular conditions. The present applicant has filed an application proposing control in this fixing mode for determining whether or not low temperature fixation is allowed for each page.

By adopting this fixing mode, further reduction of power consumption is achievable while securing toner fixation in comparison with the conventional cases. However, this method determines whether or not low temperature fixation is allowed for each page, and therefore does not reduce power consumed by high temperature fixation for apart which does not require high temperature fixation but allows low temperature fixation. In addition, the temperature of the fixing device needs to be raised to a temperature necessary for high temperature fixation by the time of a start of fixing processing for a page head. In this case, an earlier start of printing is difficult even when the page head contains a part allowing low temperature fixation.

Therefore, fixing temperature control according to the embodiment of the present invention, which aims at further reduction of the TEC value, determines whether or not low temperature fixation is allowed not for each page, but for each of bands corresponding to divisions of predetermined section units of a printing target image for each page (divisions in vertical scanning direction) so as to control a fixing temperature for each band unit.

According to this control, a temperature rise of the fixing device to a high temperature is needed only by the time of fixation of a band requiring high temperature fixation when a page head contains a band allowing low temperature fixation, for example. In this case, printing is allowed to start during a temperature rise as illustrated in FIG. 13B. In addition, the high temperature of the fixing device needs to be maintained only until fixation of a band requiring high temperature fixation when a page end contains a band allowing low temperature fixation. In this case, heating is allowed to stop after completion of fixation of the band requiring high temperature fixation as illustrated in FIG. 14B.

Accordingly, a proportion of low temperature fixation increases, wherefore energy saving is achievable through power consumption reduction. Moreover, reduction of a waiting period before a temperature rise to a fixing temperature increases efficiency of printing.

### Embodiment

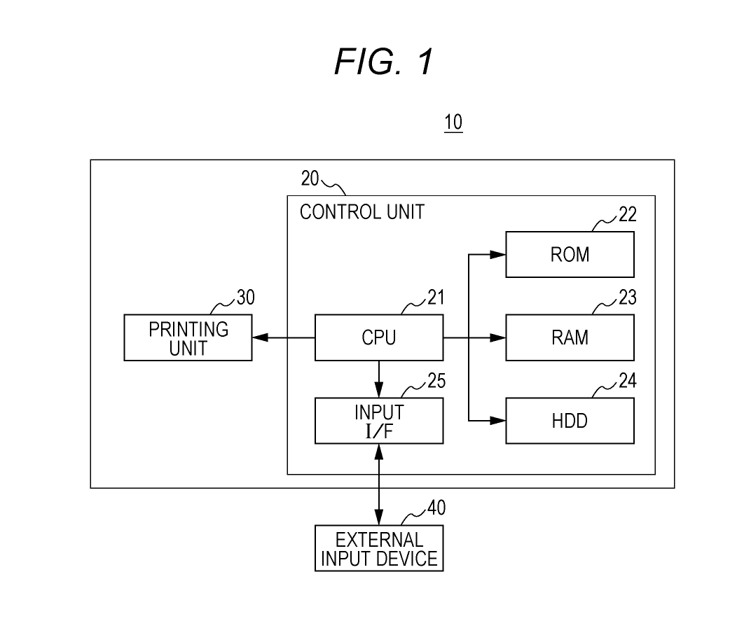

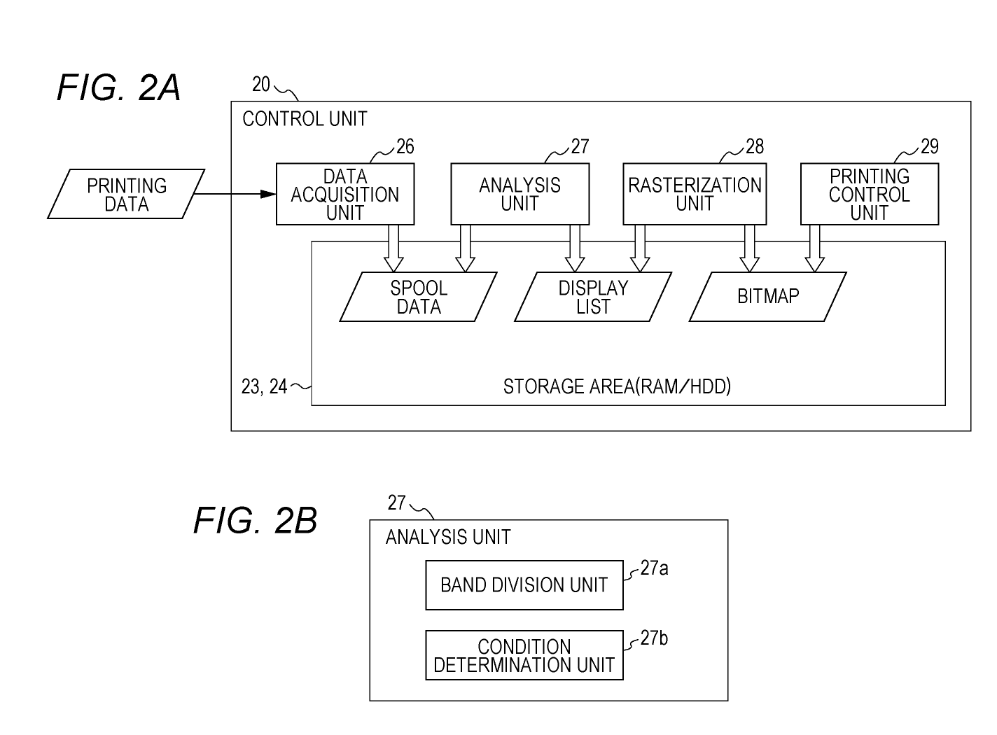

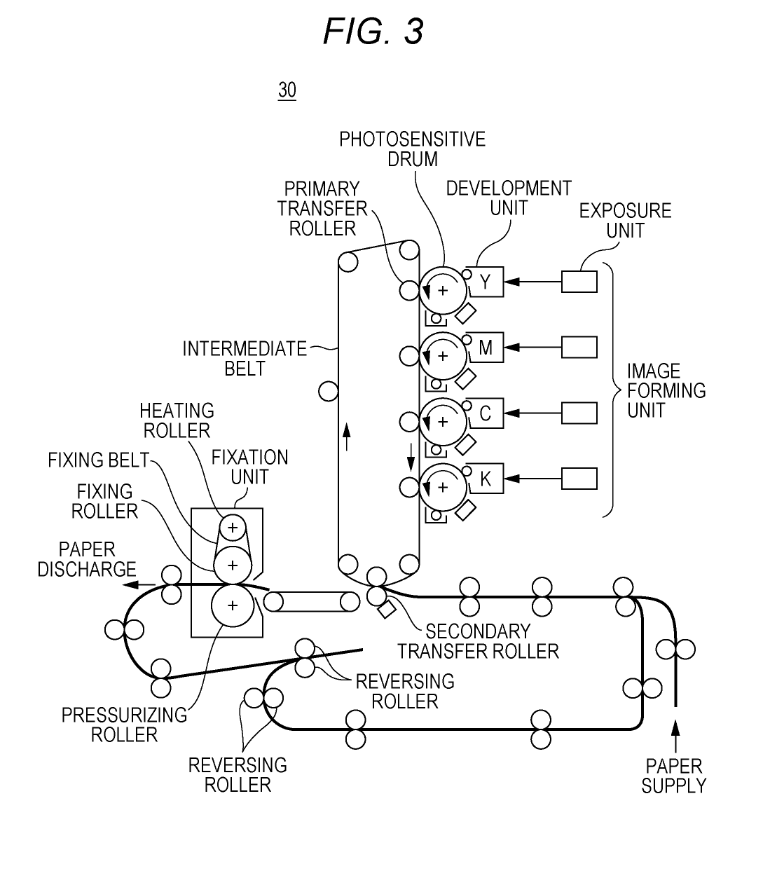

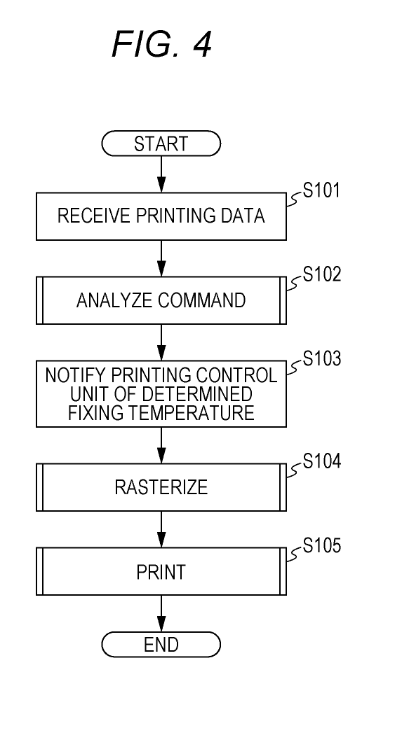

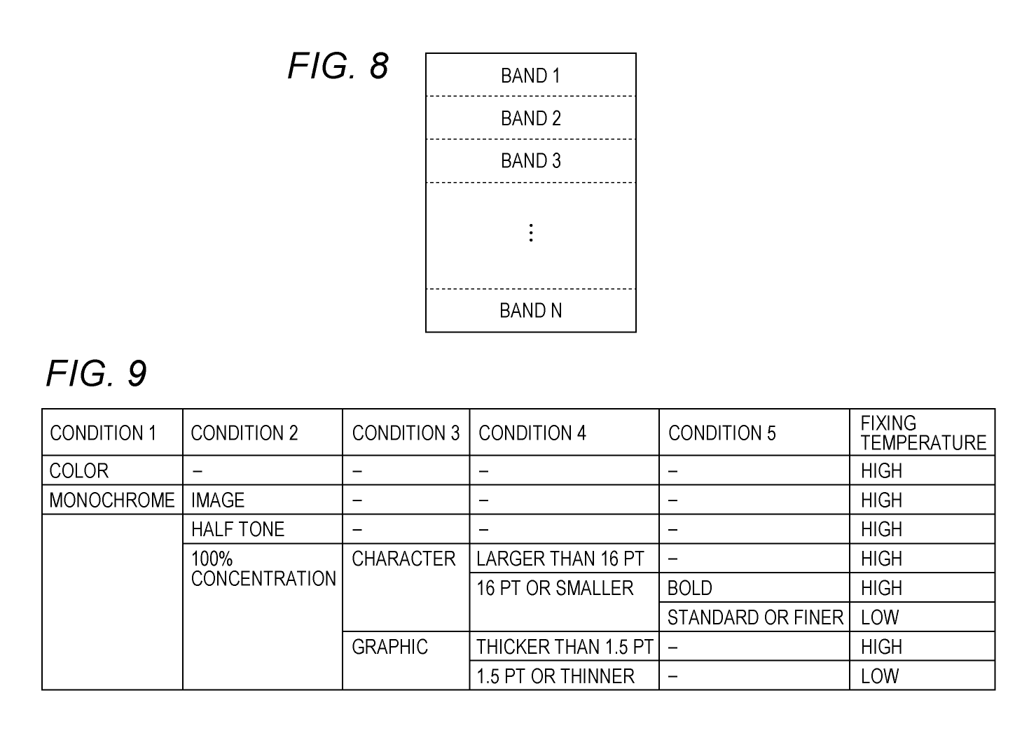

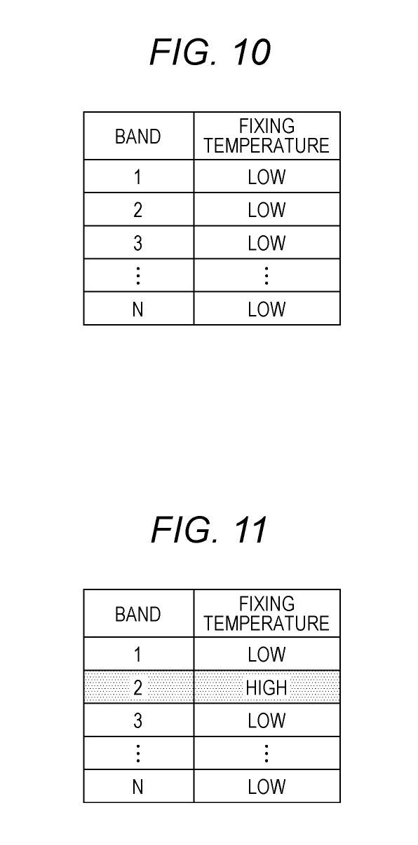

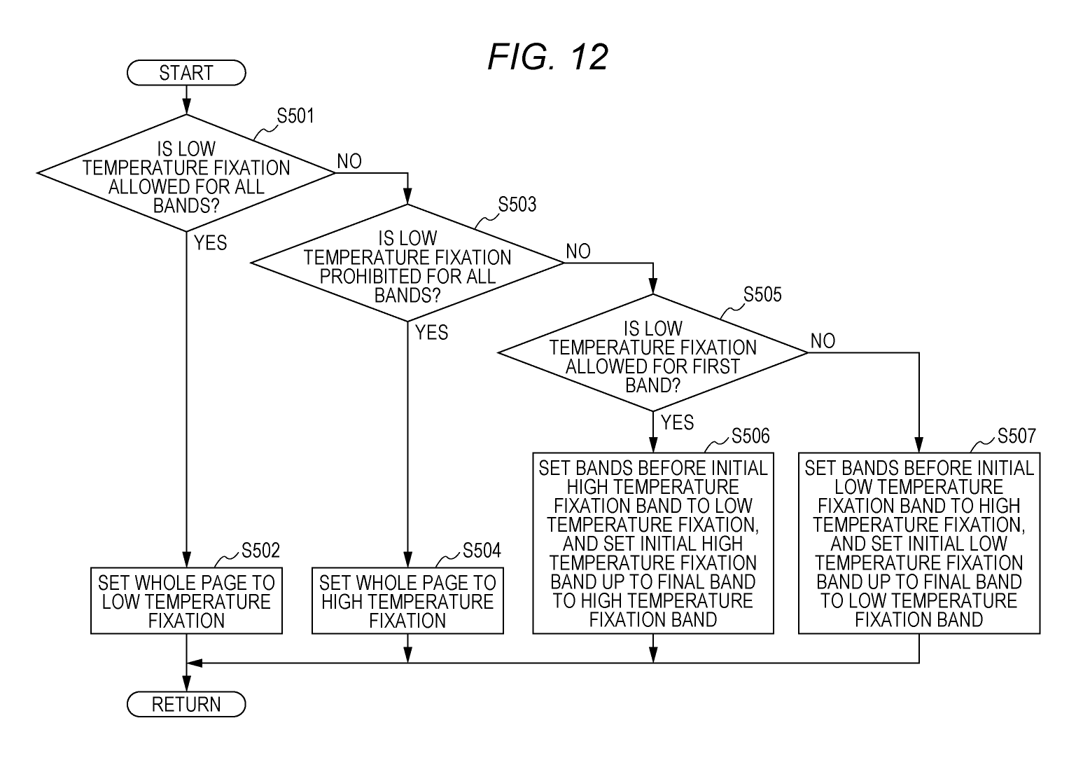

For detailing the foregoing embodiment of the present invention, described hereinafter with reference to FIGS. 1 through 14B are an image forming apparatus, a fixing temperature control method, and a fixing temperature control program according to one embodiment of the present invention. FIG. 1 is a block diagram illustrating a configuration of the image forming apparatus according to this embodiment. FIGS. 2A and 2B illustrate a configuration of a control unit and general operation of a print process. FIG. 3 is a schematic view illustrating a configuration of a printing unit. FIGS. 4 through 7 are flowcharts showing operation of the image forming apparatus according to this embodiment. FIG. 8 is a view illustrating division units (bands) of the print process. FIG. 9 is a table showing determination conditions for determining whether or not low temperature fixation is allowed. FIGS. 10 and 11 are tables each showing a relationship between bands and fixing temperatures. FIG. 12 is a flowchart showing a determination process for determining a fixing temperature according to this embodiment. FIGS. 13A through 14B show effects of fixing temperature control according to this embodiment.

An image forming apparatus 10 according to this embodiment is constituted by a multifunction machine such as a Multifunction Peripheral (MFP), or a printer, for example. The image forming apparatus 10 includes a control unit 20 and a printing unit 30 as illustrated in FIG. 1.

The control unit 20 includes a Central Processing Unit (CPU) 21, memories such as a Read Only Memory (ROM) 22 and a Random Access Memory (RAM) 23, storage units such as an Hard Disk Drive (HDD) 24, an input I/F 25, and other components. The CPU 21 is a data processing device performing calculations under programs. The ROM 22 records programs for controlling overall operation of the image forming apparatus (particularly, a fixing temperature control program for controlling a fixing temperature), and further records font data and others. The RAM 23 stores data necessary for controlling by the CPU 21, data to be temporarily stored at the time of control operation, and others. The HDD 24 stores a table describing determination conditions (described later), a table describing a correlation between bands and fixing temperatures, printing data obtained from an external input device 40 (Page Description Language (PDL) data described in page description languages such as Printer Job Language (PJL), Post Script (PS) and Printer Control Language (PCL), or Portable Document Format (PDF) data), intermediate data (display lists) created from printing data, bitmap data created from display lists, and others. The input I/F 25 is a Network Interface Card (NIC), a modem or the like, and connects with the external input device 40. The external input device 40 is a computer device or the like connected via a network such as Local Area Network (LAN) and Wide Area Network (WAN).

The control unit 20 functions as a printer controller for instructing the printing unit 30 to perform printing. More specifically, as illustrated in FIG. 2A, the control unit 20 includes a data acquisition unit 26, an analysis unit 27, a rasterization unit 28, a printing control unit 29, and others.

The data acquisition unit 26 receives printing data from the external input device 40 via the input I/F 25, and stores the received printing data in the RAM 23 or the HDD 24 as spool data.

The analysis unit 27 separates the printing data into a PDL command and data on respective pages, and interprets the PDL command to create display lists for respective bands. The analysis unit 27 stores the created display lists in the RAM 23 or the HDD 24. More specifically, as illustrated in FIG. 2B, the analysis unit 27 includes a band division unit 27a which divides each page into a plurality of parts (bands) in the vertical scanning direction, and manages display lists for each band unit, and a condition determination unit 27b which determines whether or not low temperature fixation is allowed for each band based on determination conditions stored in the HDD 24 or others beforehand, and sets a fixing temperature based on a determination result. The fixing temperature herein includes at least two types of temperature, i.e., a high temperature which is relatively high (such as 150° C.), and a low temperature which is relatively low (such as 130° C.), for example.

The rasterization unit 28 rasterizes the display lists created by the analysis unit 27 to produce bitmap data for each band, and stores the bitmap data in the RAM 23 or the HDD 24.

The printing control unit 29 transmits the bitmap data created by the rasterization unit 28 to the printing unit 30, and instructs the printing unit 30 to perform printing. In this case, the analysis unit 27 (condition determination unit 27b) controls the fixing temperature of the fixation unit of the printing unit 30 in accordance with the fixing temperature set for each band. It is preferable that the temperature of each band is adjusted to the set fixing temperature. However, considering the need for a predetermined time for varying a fixing temperature, the fixing temperatures of the whole page are controlled such that at least the temperatures of bands determined as high temperature fixation bands are adjusted to the high fixing temperature. In other words, temperatures of bands determined as low fixing temperature bands are not required to be adjusted to the low fixing temperature.

The data acquisition unit 26, the analysis unit 27, the rasterization unit 28, and the printing control unit 29 may be constructed either as hardware or as a fixing temperature control program under which the control unit 20 functions as the data acquisition unit 26, the analysis unit 27, the rasterization unit 28, and the printing control unit 29 (particularly, as the analysis unit 27, the rasterization unit 28, and the printing control unit 29), as a program executed by the control unit 20.

The printing unit 30 is an engine which executes printing based on bitmap data in response to an instruction from the printing control unit 29. More specifically, as illustrated in FIG. 3, the printing unit 30 includes image forming units (Y, M, C, and K), an intermediate belt, a secondary transfer roller, a fixation unit, and other components. Each of the image forming units (Y, M, C, and K) includes an exposure unit, a development unit, a photosensitive drum, and a primary transfer roller. During printing, the exposure unit applies laser light to the photosensitive drum in accordance with a PWM signal corresponding to PWM-converted bitmap data to form an electrostatic latent image. The development unit develops this electrostatic latent image to form a toner image on the photosensitive drum. The toner image on the photosensitive drum is transferred to the intermediate belt by the primary transfer roller.

The toner images in respective colors formed by the image forming units (Y, M, C, and K) are transferred to the rotating intermediate belt at the same position such that the respective toner images are overlapped with each other on the intermediate belt. As a result, a color image constituted by toner in four colors is formed on the intermediate belt. Recording paper is supplied from a supply tray to the secondary transfer roller in such a manner that the recording paper and the color image on the intermediate belt arrive at the secondary transfer roller in the same timing. Then, the color image is transferred to the recording paper by operation of the secondary transfer roller, whereafter the recording paper subjected to image transfer is conveyed to the fixation unit.

The fixation unit includes a heating roller containing a halogen heater, a ceramic heater, or other types of heat source, a fixing roller, a fixing belt connecting the heating roller and the fixing roller, a pressurizing roller, and other components, for example. At the fixation unit, the paper is sandwiched between the pressurizing roller and the fixing belt disposed on the fixing roller for heating and pressurization. The paper subjected to thermal fixation is discharged to a discharge tray by a conveyance roller, or is conveyed to the position of the secondary transfer roller after the front and the rear of the paper are reversed by a reversing roller.

FIGS. 1 through 3 illustrates only an example of the image forming apparatus 10 according to this embodiment, wherefore the configuration and control of the image forming apparatus 10 may be modified in appropriate manners. For example, while the image forming apparatus 10 contains the control unit 20 functioning as a printer controller, and the printing unit 30 functioning as an engine according to the example discussed above, the printer controller and the engine may be constituted by separate devices. In addition, while printing is performed based on printing data acquired from the external input device 40 according to the example discussed with reference to FIGS. 1 through 2B, the fixing temperature control according to this embodiment is applicable to a case which performs printing based on scan data read by an image reading unit (scanner) provided on the image forming apparatus 10.

The print process executed by the image forming apparatus 10 thus constructed is hereinafter described. The CPU 21 performs processes in respective steps shown in the flowchart in FIG. 4 by executing control programs (containing fixing temperature control program) stored in the ROM. 22 or the HDD 24 and loaded into the RAM 23.

The control unit 20 (data acquisition unit 26) of the image forming apparatus 10 receives printing data (PDL data) from the external input device 40 via the input I/F 25, and stores the received printing data in the RAM 23 or the HDD 24 as spool data (S101). Then, the control unit 20 acquires printing conditions set for the image forming apparatus 10 beforehand, and reflects the printing conditions in printing of the printing data.

The control unit 20 (analysis unit 27) reads the stored printing data, analyzes a PDL command to create display lists (DLs) in an intermediate language, and stores the display lists in the RAM 23 or the HDD 24 (S102). In this case, the analysis unit 27 (band division unit 27a) divides each page of the printing data into a plurality of bands, and manages the display lists for each band. FIG. 9 illustrates an example of band divisions, where one page is constituted by a plurality of bands as uniform divisions in the vertical scanning direction (i.e., paper conveyance direction). Then, the analysis unit 27 (condition determination unit 27b) determines whether or not low temperature fixation is allowed for each band based on determination conditions stored in the HDD 24 or others beforehand, determines a fixing temperature for each band based on a determination result, and notifies the printing control unit 29 of the determined fixing temperature (S103).

The control unit 20 (rasterization unit 28) reads the stored display lists, rasterizes the display lists to create bitmap data divided for each band unit, and stores the bitmap data in the RAM 23 or the HDD 24 (S104).

The control unit 20 (printing control unit 29) sequentially reads bitmap data for each band unit at the time of completion of bitmap data for one page, transmits the data to the printing unit 30, and instructs the printing unit 30 to perform printing. Simultaneously, the control unit 20 adjusts the fixing temperature of the fixation unit to the fixing temperature set by the condition determination unit 27b for each band (S105). The printing unit 30 (print engine) performs printing of the corresponding page at the fixing temperature controlled by the printing control unit 29.

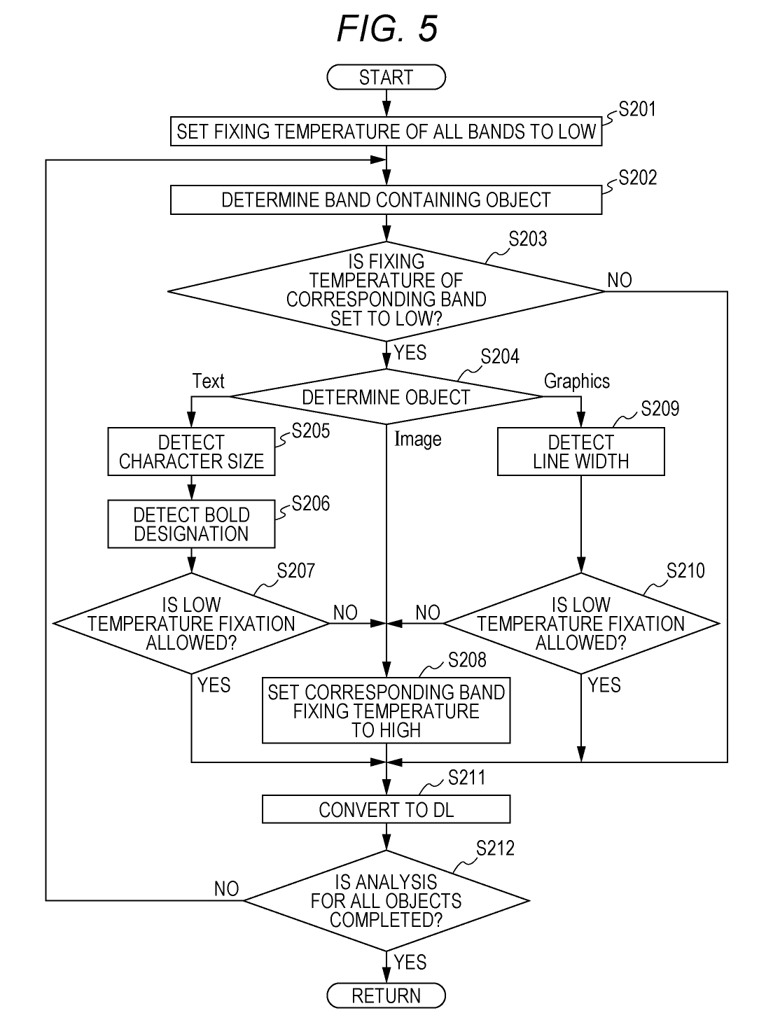

The details of a command analysis process executed in S102 are now described. The CPU 21 performs processes in respective steps shown in the flowchart in FIG. 5 by executing control programs (containing fixing temperature control program) stored in the ROM 22 or the HDD 24 and loaded into the RAM 23. The command analysis process is conducted for each of the bands divided by the analysis unit 27 (band division unit 27a). It is assumed that the determination conditions have been established beforehand and stored in the HDD 24 or others.

The analysis unit 27 manages respective fixing temperatures for each band unit, and sets the fixing temperatures of all the bands to low temperature (LOW) at a command analysis start (S201). Then, the analysis unit 27 determines the fixing temperature of the band containing analysis target objects (S202). When the fixing temperature of the corresponding band is HIGH (No in S203), i.e., when the fixing temperature is set to HIGH in S208 (described later), determination of whether or not low temperature fixation is allowed is not required. In this case, the analysis unit 27 sequentially analyzes the objects contained in the corresponding band, and converts the objects into display lists (S211).

On the other hand, when the fixing temperature of the corresponding band is LOW, the analysis unit 27 (condition determination unit 27b) determines corresponding objects (S204). More specifically, objects are classified into text objects specifying character images, graphic objects specifying graphic images, and image objects specifying picture images such as pictures. Data of each text object includes a command designating a character color, a command designating a character typeface, a command designating a character size, a command designating starting point coordinates of a position of a character, a command designating character spacing or line spacing, and text data indicating character strings, for example. Data of each graphic object includes a command designating starting point coordinates and ending point coordinates of a line constituting a figure, a command designating a line thickness, a command designating a line type (straight line or curved line), and a command designating a color or area filling, for example. Accordingly, types of an object are determined based on determination of commands contained in the data of the corresponding object.

When the corresponding object is determined as a text object based on this determination, the analysis unit 27 (condition determination unit 27b) checks a color designation, and further detects a character size based on the command (S205), and whether or not a bold character is designated (S206), in consideration of the effect of toner detachment caused by folding of the recording paper discussed above. Then, the analysis unit 27 (condition determination unit 27b) refers to the determination conditions stored in the HDD 24 or others beforehand to determine whether or not low temperature fixation is allowed for the corresponding object (S207). More specifically, the analysis unit 27 refers to the determination condition table illustrated in FIG. 10 to determine whether or not the character is monochrome, whether or not the character size is a predetermined size or smaller (16 pt or smaller in Condition 4 in this example), and whether or not the character is a non-bold character (standard or finer in Condition 5 in this example). When low temperature fixation is allowed (monochrome and standard character in the predetermined character size or smaller), the analysis unit 27 converts the corresponding object into a display list (S211). When low temperature fixation is not allowed (high temperature fixation is required), the analysis unit 27 (condition determination unit 27b) sets the fixing temperature of the corresponding band to HIGH (S208), and converts the corresponding object to a display list (S211).

When the corresponding object is determined as an image object based on the foregoing determination, adhesion of toner having a certain density or higher is required for securing fixing performance by low temperature fixation. In this case, low temperature fixation is prohibited for an image subjected to half tone processing (half tone image). Accordingly, the analysis unit 27 (condition determination unit 27b) sets the fixing temperature of the corresponding band to HIGH (S208), and converts the corresponding object to a display list (S211).

When the corresponding object is determined as a graphic object based on this determination, the analysis unit 27 (condition determination unit 27b) checks a color designation, and detects a line width based on the command (S209) in consideration of the effect of toner detachment caused by the folding of the recording paper discussed above. Then, the analysis unit 27 (condition determination unit 27b) refers to the determination conditions stored in the HDD 24 or others beforehand to determine whether or not low temperature fixation is allowed for the corresponding object (S210). More specifically, the analysis unit 27 refers to the determination condition table illustrated in FIG. 10 to determine whether or not the figure is monochrome, and whether or not the line width of the figure is a predetermined width or smaller (1.5 pt or smaller in Condition 4 in this example). When the low temperature fixation is allowed (monochrome figure having the predetermined line width or smaller), the analysis unit 27 converts the corresponding object into a display list (S211). When low temperature fixation is not allowed (high temperature fixation is required), the analysis unit 27 (condition determination unit 27b) sets the fixing temperature of the corresponding band to HIGH (S208), and converts the corresponding object to a display list (S211).

Then, the analysis unit 27 (condition determination unit 27b) determines whether or not analysis for all the objects in the corresponding page has been completed (S212). When analysis for all the objects is not completed, the flow returns to S202, and repeats the processes in S202 through S212 until completion of analysis for all the objects.

FIGS. 10 and 11 are tables for managing the fixing temperatures of the respective bands in the corresponding page. FIG. 10 shows an example of initial settings of the fixing temperatures of the respective bands at an analysis start for the corresponding page, while FIG. 11 shows an example of the fixing temperatures of the respective bands after an analysis end for the corresponding page. According to this example, a band 2 contains an object requiring high temperature fixation. Accordingly, the fixing temperature of the band 2 is switched from the initial setting “LOW” to “HIGH”. When at least one object requiring high temperature fixation is detected within a band, this band requires execution of high temperature fixation. In this case, determination of whether or not low temperature fixation is allowed is not made for other objects contained in the corresponding band so as to avoid lowering of the analysis speed. In other words, when the fixing temperature is set to HIGH in step S208, the subsequent step S203 is determined as “No”. Accordingly, steps S204 through S210 are omitted.

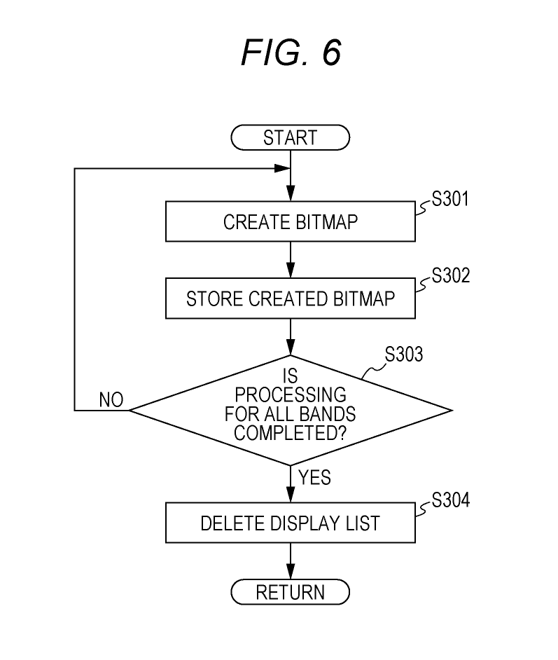

The details of a rasterization process are hereinafter described. The CPU 21 performs processes in respective steps shown in the flowchart in FIG. 6 by executing control programs (containing fixing temperature control program) stored in the ROM 22 or the HDD 24 and loaded into the RAM 23. The rasterization process is performed for each of band units corresponding to a plurality of uniform divisions of one page in the vertical scanning direction, similarly to the command analysis process discussed above.

Initially, the rasterization unit 28 reads display lists from the RAM 23 or the HDD 24 to create bitmap data for each band (S301), and stores the created bitmap data in the RAM 23 (S302). The bitmap data may be compressed for storage, or may be stored in the HDD 24 when the data even after compression is too large to be stored in the RAM 23. Then, the rasterization unit 28 determines whether or not processing for all the bands is completed (S303), and repeats processing for each band until completion of processing for one page. After completion of processing all the bands, the rasterization unit 28 deletes the corresponding display lists from the RAM 23 or the HDD 24 (S304).

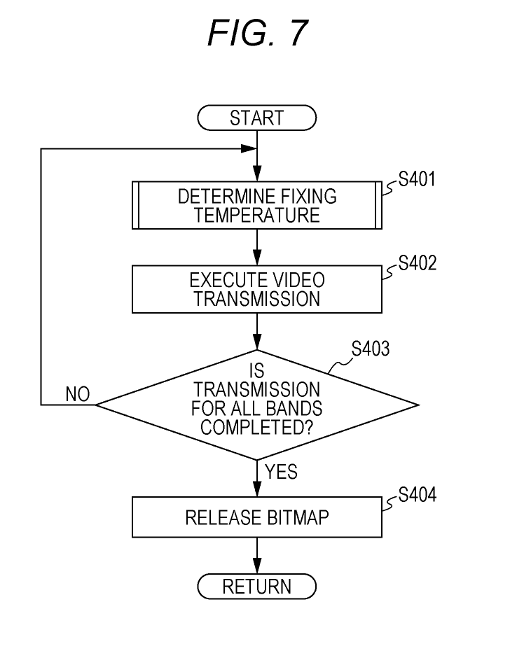

The details of a printing process are hereinafter described. The CPU 21 performs processes in respective steps shown in the flowcharts in FIGS. 7 and 12 by executing the control programs (including fixing temperature control program) stored in the ROM 22 or the HDD 24 and loaded into the RAM 23.

Initially, the printing control unit 29 determines an actual fixing temperature based on the fixing temperature for each band set by the analysis unit 27 (condition determination unit 27b) (S401). FIG. 12 is a flowchart showing details of the determination process for determining the fixing temperature. Initially, the printing control unit 29 determines whether or not low temperature fixation is allowed for all the bands (S501). When low temperature fixation is allowed for all the bands, the printing control unit 29 determines the whole of the corresponding page as a page allowing low temperature fixation (S502).

When S501 is determined as “No”, the printing control unit 29 determines whether or not low temperature fixation is prohibited for all the bands (S503). When low temperature fixation is prohibited for all the bands, the printing control unit 29 determines the whole of the corresponding page as a page requiring high temperature fixation (S504).

When S503 is determined as “No” (i.e., when a mixture of bands allowing low temperature fixation and bands requiring high temperature fixation are contained), the printing control unit 29 determines whether or not low temperature fixation is allowed for a first band (S505). When low temperature fixation is allowed for the first band (page head), the printing control unit 29 determines bands from the first band to a band immediately before an initial band requiring high temperature fixation as bands allowing low temperature fixation. In this case, the printing control unit 29 determines all the bands after the initial band requiring high temperature fixation as bands requiring high temperature fixation (S506). On the other hand, when the first band is a band requiring high temperature, the printing control unit 29 determines bands from the first band to a band immediately before an initial band allowing low temperature fixation as bands requiring high temperature fixation. In this case, the printing control unit 29 determines all the bands after the initial band allowing low temperature fixation as bands allowing low temperature fixation (S507).

Returning to FIG. 7, the printing control unit 29 reads bitmap data from the RAM 23 or the HDD 24 for each band unit, and executes video transmission of bitmap data to the printing unit 30 (print engine). Simultaneously, the printing control unit 29 controls the fixation unit to perform printing at the determined fixing temperature (S402). More specifically, the printing control unit 29 controls the fixing temperature in consideration of a temperature rise time such that the fixing temperature can be raised to a temperature necessary for high temperature fixation at the time of a start of the fixing process at least for bands determined as bands requiring high temperature fixation. Then, the printing control unit 29 determines whether or not transmission of bitmap data for all the bands is completed (S403). When transmission for all the bands is completed, the printing control unit 29 deletes bitmap data for the corresponding page from the RAM 23 or the HDD 24 (S404). Printing for one page of the recording paper now ends with completion of the foregoing processes.

According to the description of S505 through S507 in FIG. 12, all the bands are divided into two groups of the band group allowing low temperature fixation and the band group requiring high temperature fixation. However, when all the bands are divided into three or more groups of the band group allowing low temperature fixation and the band group requiring high temperature fixation, the respective bands may be determined in the following manner. When the first band allows low temperature fixation, bands from the first band to a band immediately before an initial band requiring high temperature fixation are determined as bands allowing low temperature fixation. In this case, bands from the initial band requiring high temperature fixation to a band immediately before a band allowing low temperature fixation are determined as bands requiring high temperature fixation. Thereafter, similar processes are sequentially repeated. On the other hand, when the first band requires high temperature fixation, bands from the first band to a band immediately before an initial band allowing low temperature fixation are determined as bands requiring high temperature fixation. In this case, bands from the initial band allowing low temperature fixation to a band immediately before a band requiring high temperature fixation are determined as bands allowing low temperature fixation. Thereafter, similar processes are sequentially repeated. According to this method, the printing control unit 29 controls the fixing temperature in consideration of the time required for a temperature change such that the fixing temperature can be raised to the temperature necessary for high temperature fixation at the time of a start of the fixing process at least for bands determined as bands requiring high temperature fixation, similarly to the above case.

According to this embodiment, therefore, whether or not low temperature fixation is allowed is determined for each of band units corresponding to divisions of a page in the vertical scanning direction with reference to determination conditions established beforehand so that the fixing temperature can be set based on determination results. Accordingly, power consumed by fixing processing sufficiently decreases even when a page contains a mixture of bands requiring high temperature fixation and bands allowing low temperature fixation. In addition, efficiency of printing increases with an earlier start of printing depending on positions of bands allowing low temperature fixation.

More specifically, according to the conventional method which determines whether or not low temperature fixation is allowed for each page, printing does not start until arrival of a temperature necessary for high temperature fixation when a page contains an object requiring high temperature fixation as illustrated in FIG. 13A. On the other hand, according to the method of this embodiment which determines whether or not low temperature fixation is allowed for each band, printing starts for a band allowing low temperature fixation at the time of arrival of a predetermined temperature necessary for low temperature fixation as illustrated in FIG. 13B. Accordingly, power consumed by fixing processing sufficiently decreases, and printing starts earlier when a page head contains a band allowing low temperature fixation.

Moreover, according to the conventional method which determines whether or not low temperature fixation is allowed for each page, the high fixing temperature needs to be maintained until completion of fixation of a page end when a page contains an object requiring high temperature fixation as illustrated in FIG. 14A. However, according to the method of this embodiment which determines whether or not low temperature fixation is allowed for each band, the fixing temperature is allowed to lower at the time when there remain only bands allowing low temperature fixation as illustrated in FIG. 14B. Accordingly, power consumed by fixing processing decreases.

The present invention is not limited to the embodiment described herein. The configuration and control of the image forming apparatus may be modified in appropriate manners without departing from the scope and spirit of the present invention.

For example, the fixing temperature is set to either the high temperature or the low temperature in the foregoing embodiment. However, the fixing temperature control according to the present invention is applicable to the fixing temperature set to any one of three or more temperatures, including at least one intermediate temperature between the high temperature and the low temperature.

The present invention is applicable to an image forming apparatus and a fixing temperature control method capable of thermally fixing a toner image formed on recording paper for printing, and further to a fixing temperature control program operating in this image forming apparatus, and a recording medium recording this fixing temperature control program.

According to an embodiment of the image forming apparatus, the fixing temperature control method, and the fixing temperature control program, whether or not low temperature fixation is allowed is determined for each of band units corresponding to divisions of a page in the vertical scanning direction. Accordingly, power consumed by fixing processing sufficiently decreases even when a page contains a mixture of a part requiring high temperature fixation and a part allowing low temperature fixation. In addition, printing is allowed to start before arrival at a fixing temperature necessary for high temperature fixation when a page head contains a band allowing low temperature fixation. Accordingly, efficiency of printing increases. Moreover, toner detachment at the time of folding is taken into consideration in determining whether or not low temperature fixation is allowed. Accordingly thermal fixation is performed at an appropriate temperature.

Although the present invention has been described and illustrated in detail, it is clearly understood that the same is by way of illustrated and example only and is not to be taken by way of limitation, the scope of the present invention being interpreted by terms of the appended claims.

What is claimed is:

1. An image forming apparatus comprising:
a printing unit that includes
an image forming unit that forms a toner image of each page on recording paper based on printing data, and
a fixation unit that thermally fixes the toner image on the recording paper; and
a control unit that controls the printing unit and includes
a data acquisition unit that acquires the printing data,
an analysis unit that analyzes the printing data and creates a display list,
a rasterization unit that creates bitmap data based on the display list, and
a printing control unit that transmits the bitmap data to the printing unit, and instructs the printing unit to perform printing, wherein
the analysis unit includes
a band division unit that divides each page into a plurality of bands, and
a condition determination unit that determines whether or not low temperature fixation executed at a relatively low temperature is allowed for each of the bands, and sets a fixing temperature for each of the bands based on a determination result, and
the printing control unit controls a fixing temperature of the fixation unit based on the fixing temperature set for each of the bands.

2. The image forming apparatus according to claim 1, wherein the condition determination unit executes a determination process for determining whether or not low temperature fixation is allowed based on at least one of determination conditions established for each object contained in a determination target band, the determination conditions containing a type of the corresponding object, whether the corresponding object is colored or monochrome, whether or not the corresponding object is a half tone object, whether or not the corresponding object contains a character in a predetermined size or smaller, whether or not the corresponding object contains a figure line in a predetermined width or smaller, and whether or not the corresponding object contains a bold character.

3. The image forming apparatus according to claim 2, wherein, when determining that low temperature fixation is prohibited for one object contained in a determination target band, the condition determination unit does not execute the determination process for other objects contained in the corresponding band.

4. The image forming apparatus according to claim 1, wherein, when a band at a page head is determined as a band allowing low temperature fixation in a state that a printing target page contains a mixture of bands allowing low temperature fixation and bands prohibiting low temperature fixation, the printing control unit allows the printing unit to start printing at the time when a temperature of the fixation unit reaches a temperature necessary for the low temperature fixation.

5. The image forming apparatus according to claim 1, wherein, when a band at a page end is determined as a band allowing low temperature fixation in a state that a printing target page contains a mixture of bands allowing low temperature fixation and bands prohibiting low temperature fixation, the printing control unit performs control for lowering a fixing temperature of the fixation unit at the time of completion of fixation of a band located before the corresponding band at the page end and determined as a band prohibiting low temperature fixation.

6. A fixing temperature control method for an image forming apparatus that includes
a printing unit that includes
an image forming unit that forms a toner image of each page on recording paper based on printing data, and
a fixation unit that thermally fixes the toner image on the recording paper,
the method executing:
a data acquisition process that acquires the printing data;
an analysis process that analyzes the printing data and creates a display list;
a rasterization process that creates bitmap data based on the display list; and
a printing process that transmits the bitmap data to the printing unit, and instructs the printing unit to perform printing, wherein
the analysis process divides each page into a plurality of bands, determines whether or not low temperature fixation executed at a relatively low temperature is allowed for each of the bands, and sets a fixing temperature for each of the bands based on a determination result, and
the printing process controls a fixing temperature of the fixation unit based on the fixing temperature set for each of the bands.

7. The fixing temperature control method according to claim 6, wherein the analysis process executes a determination process for determining whether or not low temperature fixation is allowed based on at least one of determination conditions established for each object contained in a determination target band, the determination conditions containing a type of the corresponding object, whether the corresponding object is colored or monochrome, whether or not the corresponding object is a half tone object, whether or not the corresponding object contains a character in a predetermined size or smaller, whether or not the corresponding object contains a figure line in a predetermined width or smaller, and whether or not the corresponding object contains a bold character.

8. The fixing temperature control method according to claim 7, wherein, when determining that low temperature fixation is prohibited for one object contained in a determination target band, the analysis process does not execute the determination process for other objects contained in the corresponding band.

9. The fixing temperature control method according to claim 6, wherein, when a band at a page head is determined as a band allowing low temperature fixation in a state that a printing target page contains a mixture of bands allowing low temperature fixation and bands prohibiting low temperature fixation, the printing process allows the printing unit to start printing at the time when a temperature of the fixation unit reaches a temperature necessary for the low temperature fixation.

10. The fixing temperature control method according to claim 6, wherein, when a band at a page end is determined as a band allowing low temperature fixation in a state that a printing target page contains a mixture of bands allowing low temperature fixation and bands prohibiting low temperature fixation, the printing process performs control for lowering a fixing temperature of the fixation unit at the time of completion of fixation of a band located before the corresponding band at the page end and determined as a band prohibiting low temperature fixation.

11. A non-transitory recording medium storing a computer readable fixing temperature control program, the program operating in an apparatus that controls a printing unit including
an image forming unit that forms a toner image of each page on recording paper based on printing data, and
a fixation unit that thermally fixes the toner image on the recording paper, wherein
under the program, the apparatus executes
an analysis process that analyzes the printing data and creates a display list,
a rasterization process that creates bitmap data based on the display list, and
a printing process that transmits the bitmap data to the printing unit, and instructs the printing unit to perform printing, and
the analysis process divides each page into a plurality of bands, determines whether or not low temperature fixation executed at a relatively low temperature is allowed for each of the bands, and sets a fixing temperature for each of the bands based on a determination result, and
the printing process controls a fixing temperature of the fixation unit based on the fixing temperature set for each of the bands.

12. The non-transitory recording medium storing a computer readable fixing temperature control program according to claim 11, wherein the analysis process executes a determination process for determining whether or not low temperature fixation is allowed based on at least one of determination conditions established for each object contained in a determination target band, the determination conditions containing a type of the corresponding object, whether the corresponding object is colored or monochrome, whether or not the corresponding object is a half tone object, whether or not the corresponding object contains a character in a predetermined size or smaller, whether or not the corresponding object contains a figure line in a predetermined width or smaller, and whether or not the corresponding object contains a bold character.

13. The non-transitory recording medium storing a computer readable fixing temperature control program according to claim 12, wherein, when determining that low temperature fixation is prohibited for one object contained in a determination target band, the analysis process does not execute the determination process for other objects contained in the corresponding band.

14. The non-transitory recording medium storing a computer readable fixing temperature control program according to claim 11, wherein, when a band at a page head is determined as a band allowing low temperature fixation in a state that a printing target page contains a mixture of bands allowing low temperature fixation and bands prohibiting low temperature fixation, the printing process allows the printing unit to start printing at the time when a temperature of the fixation unit reaches a temperature necessary for the low temperature fixation.

15. The non-transitory recording medium storing a computer readable fixing temperature control program according to claim 11, wherein, when a band at a page end is determined as a band allowing low temperature fixation in a state that a printing target page contains a mixture of bands allowing low temperature fixation and bands prohibiting low temperature fixation, the printing process performs control for lowering a fixing temperature of the fixation unit at the time of completion of fixation of a band located before the corresponding band at the page end and determined as a band prohibiting low temperature fixation.
